(19) United States
(12) Patent Application Publication
(10) Pub. No.: US 2013/0166675 A1
(43) Pub. Date: Jun. 27, 2013

(54) Computer System and Computer Method for Coarse-Grained Data Access

(71) Applicants: Dirk Giebel, Walldorf (DE); Jens Weiler, Weingarten (DE); Udo Klein, Maximiliansau (DE); Thomas Gauweiler, Speyer (DE); Heiko Steffen, Ruelzheim (DE); Joachim Fitzer, Schriesheim (DE); Jan Teichmann, Neustadt/Weinstrasse (DE); Frank Brunswig, Heidelberg (DE); Daniel Hutzel, Karlsruhe (DE); Steffen Tatzel, Nussloch (DE); Daniel Goldman, Mannheim (DE)

(72) Inventors: Dirk Giebel, Walldorf (DE); Jens Weiler, Weingarten (DE); Udo Klein, Maximiliansau (DE); Thomas Gauweiler, Speyer (DE); Heiko Steffen, Ruelzheim (DE); Joachim Fitzer, Schriesheim (DE); Jan Teichmann, Neustadt/Weinstrasse (DE); Frank Brunswig, Heidelberg (DE); Daniel Hutzel, Karlsruhe (DE); Steffen Tatzel, Nussloch (DE); Daniel Goldman, Mannheim (DE)

(73) Assignee: SAP AG, Walldorf (DE)

(21) Appl. No.: 13/333,781

(22) Filed: Dec. 21, 2011

(51) Int. Cl. G06F 15/16

(52) U.S. Cl. 709/217

(57) ABSTRACT

A computerized method for accessing business object data stored in a data buffer of a server computer includes providing an application program interface (API) having a function for specifying a set of paths through a business object stored as a data structure in a data buffer of a server computer. Each of the paths included in the set of paths specifies a plurality of nodes of the business object for accessing hosted data at the plurality of nodes. The method further includes receiving a set of parameters for the function of the API. The set of parameters specify the set of paths. The method further includes issuing the set of parameters to the server computer, retrieving hosted data from the plurality of nodes for each path in the set of paths; and transmitting to a client the hosted data retrieved from the plurality of nodes.

### BACKGROUND

The present invention generally relates to data access from a server, and more particularly relates to coarse-grained data retrieval from a server having data buffers configured to store the data.

Unless otherwise indicated herein, the approaches described in this section are not prior art to the claims in this application and are not admitted to be prior art by inclusion in this section.

Computer systems that provide data hosting and applications that operate on hosted data are becoming increasingly popular. Businesses, government entities, and other organizations (generally referred to as users herein) with relatively large bodies of data are increasingly using such computer systems to host their data. Such computer system are typically maintained and operated by businesses that are independent from users, which contract with the businesses for the use of such computer systems for hosting data. Computer systems configured to host data and provide applications for the hosted data provide numerous advantages for users, such as: reducing user-overhead costs, providing reliable access to hosted data via a variety of computer platforms (e.g., desktop computers, laptop computers, tablet computers, etc.), global access to hosted data, a large variety of applications available for the hosted data, and the like.

Users generally have a desire to have relatively quick access to the user's hosted data hosted on a computer system, such as a server. Traditional servers are configured to provide for a user, via a user computer, to send data requests for hosted data stored in the server's data buffers and return the hosted data requested to the user computer. For hosted data stored in the form of a data structure, such as a tree data structure, in a data buffer of a server, a user computer typically sends a data request for hosted data stored in each node of the tree. That is, one data request is sent to a traditional server for each node from which hosted data is requested. Therefore, to retrieve data from a plurality of nodes, a corresponding plurality of data requests are sent from a user computer to a server. After each data request is sent by the user computer, the server computer typically responds by sending the hosted data at the node from which the hosted data is requested and sends an identifier that identifies the next node of the tree so that the computer system might then request additional hosted data at the next node. The user computer and server continue this back-and-forth process for retrieving hosted data stored in a data structure until the relevant nodes of the data structure have been accessed and hosted data retrieved therefrom. This process of a user computer issuing a request for hosted data from each node of a data structure is relatively slow.

Thus, there is a need for providing an improved computer system and an improved computer method for retrieval of hosted data stored in a data structure in a data buffer of the server computer to reduce the number of communications between a user computer and the server computer for retrieving the hosted data.

### SUMMARY

The present invention generally relates to data retrieval from a server, and more particularly relates to coarse grained data retrieval from a server having data buffers configured to store the data.

According to one embodiment of the present invention, a computerized method for retrieval of coarse-grained business object data stored in a data buffer of a server computer includes providing via a computer system an application program interface (API) having a function for specifying a set of paths through a business object stored as a data structure in a data buffer of a server computer. Each of the paths included in the set of paths specifies a plurality of nodes of the business object for accessing hosted data at the plurality of nodes. The method further includes receiving via the computer system a set of parameters for the function of the API, wherein the set of parameters specify the set of paths, and issuing via the computer system the set of parameters to the server computer. The method further includes retrieving via the computer system hosted data from the plurality of nodes for each path in the set of paths, and transmitting via the computer system to a client the hosted data retrieved from the plurality of nodes.

According to a specific embodiment, the method further includes presenting via the computer system on the client the hosted data according to a tree structure specified by the set of paths.

According to another specific embodiment, the retrieving step includes parsing via the computers system the set of parameters for each path.

According to a specific embodiment, the retrieving step includes traversing each path in the set of paths for the business object stored in the data buffer.

According to a specific embodiment, the set of parameters includes a first parameter for specifying a business object node instance and an association from the business instance to sub-nodes of the instance.

According to a specific embodiment, the level of the instance is an arbitrary node for the instance.

According to a specific embodiment, the association is a name of the sub-node or a modeled or implemented relationship to the sub-node.

According to a specific embodiment, the set of parameters includes a name for the instance from which the association specifies the sub-node of the instance.

According to a specific embodiment, each of the associations is a name for one of the sub-nodes or a modeled or implemented relationship to the sub-node.

According to a specific embodiment, the association specifies an association between the instance and the sub-nodes of the instance.

According to a specific embodiment, the set of parameters includes a name for the instance from which the association specifies the sub-node of the instance.

According to a specific embodiment, the set of parameters includes a sub-set of parameters for specifying the inclusion of link information in the hosted data retrieved from the plurality of nodes and transmitted to the client.

According to another embodiment of the present invention, a non-transitory computer readable medium includes a computer program product, which includes steps for retrieving coarse-grained data for a computerized method including providing via a computer system an application program interface (API) having a function for specifying a set of paths through a business object stored as a data structure in a data buffer of a server computer. Each of the paths included in the set of paths specifies a plurality of nodes of the business object for accessing hosted data at the plurality of nodes. The method further includes receiving via the computer system a set of parameters for the function of the API, wherein the set of parameters specify the set of paths, and issuing via the computer system the set of parameters to the server computer. The method further includes retrieving via the computer system hosted data from the plurality of nodes for each path in the set of paths, and transmitting via the computer system to a client the hosted data retrieved from the plurality of nodes.

According to another embodiment of the present invention, a computer system configured for accessing retrieving coarse-grained data business object data stored in a data buffer of a server computer includes a set of processors configured to execute computer code. The computer system further includes a set of memories respectively coupled to the set of processors and configured to store computer code and transfer the computer code to the set of processors for execution, wherein the computer code includes computer code for providing via a computer system an application program interface (API) having a function for specifying a set of paths through a business object stored as a data structure in a data buffer of a server computer. Each of the paths included in the set of paths specifies a plurality of nodes of the business object for accessing hosted data at the plurality of nodes. The set of memories further includes computer code for receiving via the computer system a set of parameters for the function of the API, wherein the set of parameters specify the set of paths, and computer code for issuing via the computer system the set of parameters to the server computer. The set of memories further includes computer code for retrieving via the computer system hosted data from the plurality of nodes for each path in the set of paths, and computer code for transmitting via the computer system to a client the hosted data retrieved from the plurality of nodes.

The following detailed description and accompanying drawings provide a better understanding of the nature and advantages of the present invention.

### BRIEF DESCRIPTION OF THE DRAWINGS

FIG. 1 is a simplified schematic of a computer system according to one embodiment of the present invention;

FIG. 2 is a further detailed view of the computer system shown in FIG. 1 according to a further embodiment of the present invention;

FIG. 3, which is a high-level flow diagram of a computerized method for coarse-grained data retrieval according to one embodiment of the present invention;

FIG. 4A is a simplified schematic of the parameters for the request function provided by an LCP API according to one embodiment of the present invention

FIG. 4B is a simplified schematic showing a hierarchy of nodes (e.g., tree structure) of a business object, for example of a sales order business object according to a sales order example being considered; and

FIG. 4C is a simplified schematic showing a hierarchy of nodes of a business object, for example, of a sales order business object for returned sales order business object data according to a sales order example being considered.

### DETAILED DESCRIPTION

The present invention generally provides a computer system and a computer method for retrieval of hosted data stored on a server, and more particularly provides for coarse-grained data retrieval from a server having a data buffer configured to store the hosted data.

In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include modifications and equivalents of the features and concepts described herein.

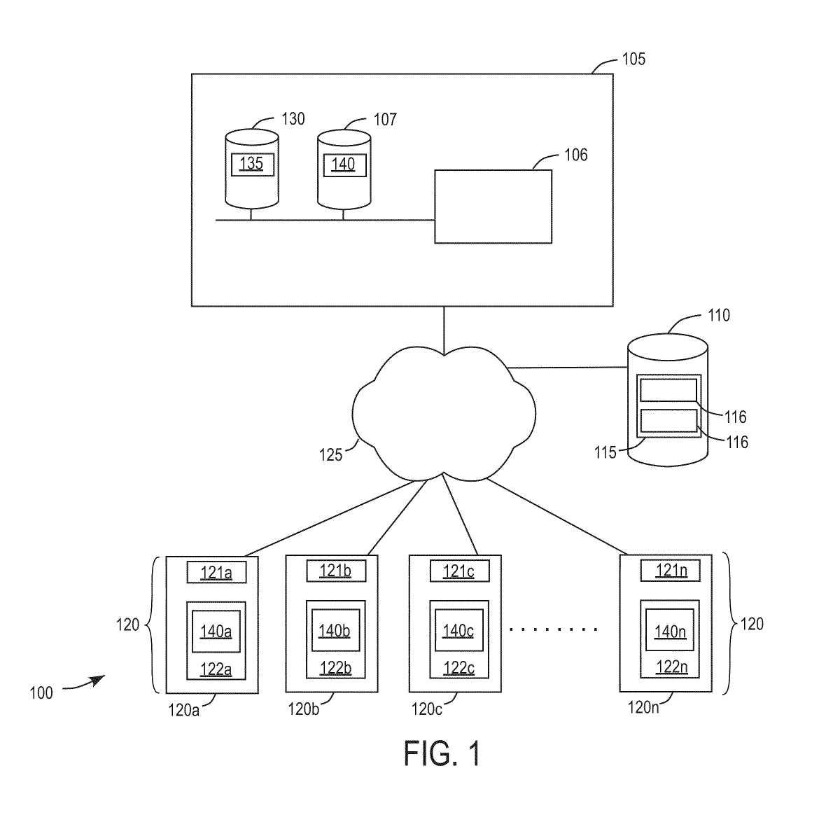

FIG. 1 is a simplified schematic of a computer system 100 according to one embodiment of the present invention. Computer system 100 includes a server computer 105, a computer storage 110 configured store a database 115, a set of user computers 120, and a computer network 125 communicatively linking server computer 105 and the set of user computers 120. Each user computer in the set of user computers 120 is labeled with the base reference numeral 120 and an alphabetic suffix. A set as referred to herein includes one or more elements. Computer network 125 may also link server computer 105 to computer storage 110. Computer network 125 may include one or more intranets, the Internet, or the like. Various portions of computer network 125 may not be accessible to other portion of the computer network. For example, various intranets included in computer network 125 might not be accessible to various other intranets included in computer network 125.

Server computer 105 may be configured to operate a server operating system and may include set of processors 106 and a non-transitory memory 107. Non-transitory memory 107 may be configured to store computer code 109, which may be executable by the set of processors 106 of server computer 105 or executable by other server computers. Each user computer may be a desktop computer, a laptop computer, a tablet computer, a smartphone, a personal digital assistant, or the like. Further, each user computer may include a set of processors 121 (the sets of processors are labeled 121a, 121b, 121c . . . 121n in FIG. 1) and a non-transitory memory 122 (the non-transitory memories are labeled 122a, 122b, 122c . . . 122n in FIG. 1) on which computer code may be stored. The computer code stored on a non-transitory memory 122 may be executable by an associated processor 121 of a user computer. A non-transitory memory may include semiconductor memory, optical memory, magnetic memory, or the like. The computer code stored on non-transitory memories 107 and 122 may encode the computer methods described herein and during operation a processor may carry out the steps of the computer method embodiments described herein.

According to one embodiment, server computer 105 is a business-objects server configured to store, modify, and access data objects 116 (referred to herein as business objects) in database 115. According to a further embodiment, server computer 105 is an advanced business application programming (ABAP) application server, which is a specific type of business-objects server. ABAP is a high-level programming language created by SAP AG of Germany, and is a language that may be used for programming the server computer for building applications that provide services, such as building business applications. More specifically, server computer 105 may be a Business By Design Server of SAP AG of Germany.

According to one embodiment, server computer 105 further includes a data buffer 130 configured to store a set of business objects 135. The set of business objects 135 may be stored in data buffer 130 as a business-object data structure, such as a tree data structure. The set of business objects 135 may be a copy of business objects 116 stored in database 115 or may be a subset of business objects 116. The set of business objects 135 may alternatively be based on business objects 116 and may be a modification thereof. For example, business objects 116 may initially be retrieved from database 115 and stored in data buffer 130 and may thereafter be modified, possibly for subsequent storage back into database 115.

The user computers in the set of user computer 120 may be configured for operating a set of clients 140 (each client is labeled with the base reference numeral 140 and an alphabetic suffix). The clients operating on the user computers may be configured for use by different users controlling the different clients. For example, computer 120a may be configured for operating a development tool client 140a for developing new applications within a development framework or the like. According to a further example, user computer 120b may be configured to operate a front-end client 140b, such as a browser or other dedicated client, for use by user computer 120b for accessing a user's hosted data stored in data buffers 130. According to a further example, user computer 120c may be configured to operate a client 120c for generic consumers, such as agents, extensions, etc.

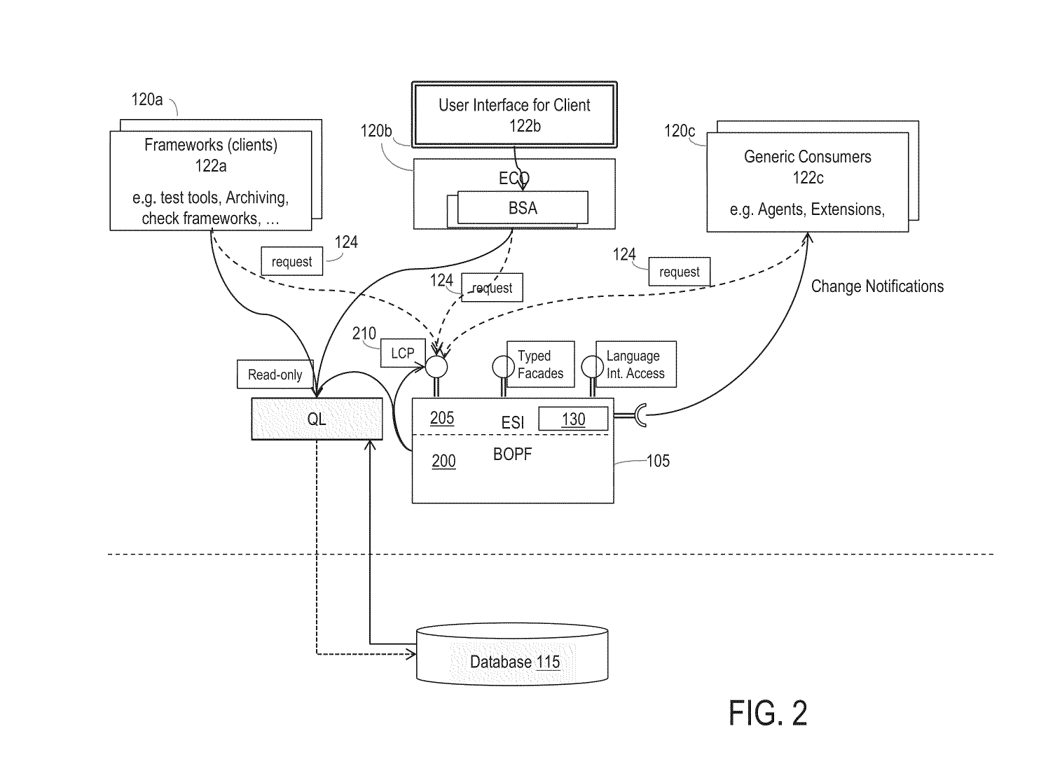

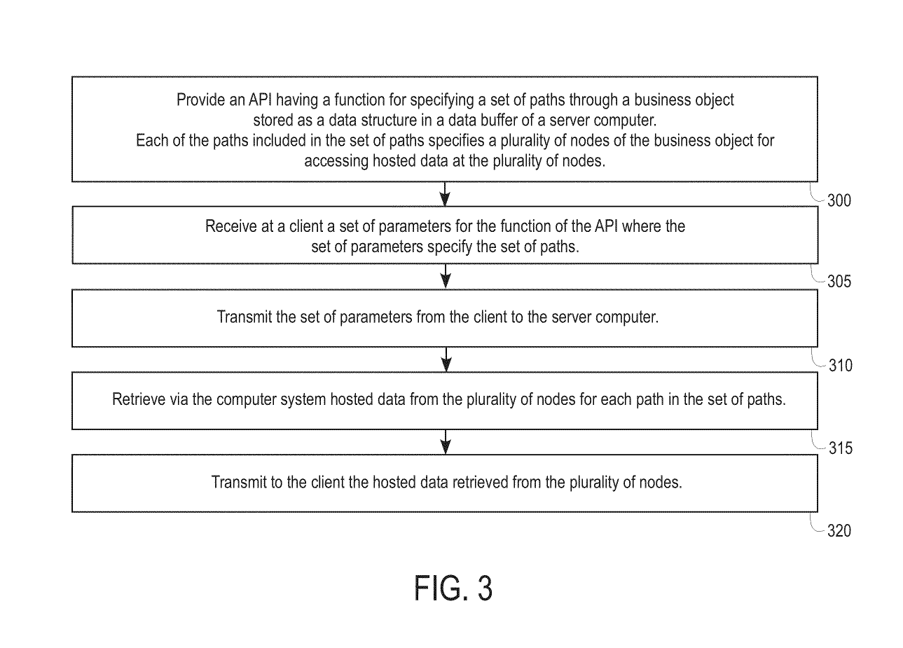

FIG. 2 is a further detailed schematic of computer system 100 according to one embodiment of the present invention. FIG. 2 is referred to in combination with FIG. 3, which is a high-level flow diagram of a computer method according to one embodiment of the present invention. The high-level flow diagram is exemplary. It will be understood by those of skill in the art the steps in the high-level flow diagram may be combined and/or steps may be added without deviating from the spirit and purview of the embodiment. According to one embodiment server computer 105 is configured to operate a business object process framework (BOPF) 200, which is an application specific framework configured for use in transportation management of hosted data between database 115, data buffer 130, and clients 122, which operate on user computers 122. Server computer 105 is further configured to operate an enterprise service infrastructure (ESI) framework 205 in which a local client proxy (LCP) 210 is configured to operate. LCP 210 is an application program interface (referred to herein as LCP API) configured to provide a request function for requesting business object services, such as RETRIEVE and MODIFY, etc., which may be executed by clients 122, wherein the request function may be a request 124 for hosted data stored in data buffer 130 (step 300). The LCP API (or more specifically the request function of the LCP API and parameters of the request function) may be accessed and used by clients 122 for formulating requests 124 via receipt of the parameters for the request function (step 305) and issuing the requests (step 310) for the hosted data stored in the data buffers, for example, for retrieval or modification of the hosted data. Via use of the LCP API, the requests for hosted data formulated and issued by the clients may be coarse-grained data requests. The coarse-grained data requests are configured to allow a set of paths in a business-object data structure to be specified for retrieval of hosted data (e.g., business objects) at a plurality of nodes of the business-object data structure. For example, a set of paths may specify a tree data structure, which may be a portion of the business-object data structure of the hosted data stored in data buffer 130. Each path is a branch of the tree data structure. Further, each branch specifies a plurality of nodes of the business-object data structure of the hosted data stored in data buffer 130. According to one embodiment, hosted data may be retrieved from the plurality of nodes (e.g., as specified by the sets of paths) of the business-object data structure via a single request formulated according to embodiments of the present invention. The request may be issued by a client to the ESI and the BOPF for access to the hosted data.

Traditionally, LCP APIs have provided functions for clients 122 where the clients interact with a server computer and data buffers (via the provided functions) for node by node requests for hosted data stored in business-object data structure in the data buffers. As described briefly above, according to one embodiment of the present invention, the LCP API 210 is configured to provide the request function for accessing the hosted data stored in data buffer 130 according a set of paths in the business-object data structure. Specifically, the set of paths specified (via the request function and function parameters of the LCP API) define a composition of a tree data structure starting at a first specified node of the tree data structure, for example a root node. The set of paths may also specify the sub-nodes of the root node, sub-sub nodes of the root node, etc. for retrieval of hosted data from the root node, the sub-nodes, the sub-sub nodes, etc. In addition to specifying the nodes from which hosted data is to be retrieved, the set of paths may also specify the associates between nodes (e.g., root node, sub-nodes, sub-sub-nodes, etc.) in the tree data structure. The associations provide that the BOPF (after receiving a course-grained data request for hosted data) and may traverse the sets of paths in the business-object data structure by parsing the associations provided in coarse-grained data request. That is, the associations map the set of paths for the BOPF for retrieval of the hosted data at the nodes (e.g., root item data from a root node, sub-item data from sub-nodes, sub-sub-item data from sub-sub nodes, etc.). See step 315. For convenience herein, root item data is sometimes referred to as an item, sub-item data is sometimes referred to as a sub-item, etc.

According to one embodiment of the present invention, the BOPF is further configured to construct a formulation of the hosted data requested in a coarse-grained data request and return the formulation of the hosted data to the client that requested the hosted data (step 320). The formulation of the hosted data prepared by the BOPF for transfer to the client requesting the hosted data may be organized according to the set of paths (i.e., according to the tree data structure specified by the sets of paths). That is, the formulation of the hosted data provides for the hosted data to be organized from to a first specified node (e.g., the root node) in the coarse-grained data request, to the sub-node (e.g., specified by a first association in the course-grained data request), to the sub-sub node (e.g., specified by a second association in the course-grained data request), etc.

The parameters of the request function, which is provided by the LCP API, for specifying the set of paths in the business-object data structure for the hosed data stored in the buffer memory is described in further detail immediately below. The parameters for the request function may be entered into a requesting program, a requesting script, etc. via a user interface of a client (e.g., client 122b), via another program generating the requesting program, the requesting script, etc. where the requesting program, the requesting script, etc. may include a request function call for the request function and may generate the coarse-grained data request 124. According to one embodiment, the parameters may be entered by a human user using the user interface of one of the clients to generate a requesting program, a requesting script, etc. for generating the course-grained data request 124. The entry of parameters for a request function provided by an API, such as LCP API 210, is generally well understood by those of skill in the art and will not be described in further detail herein.

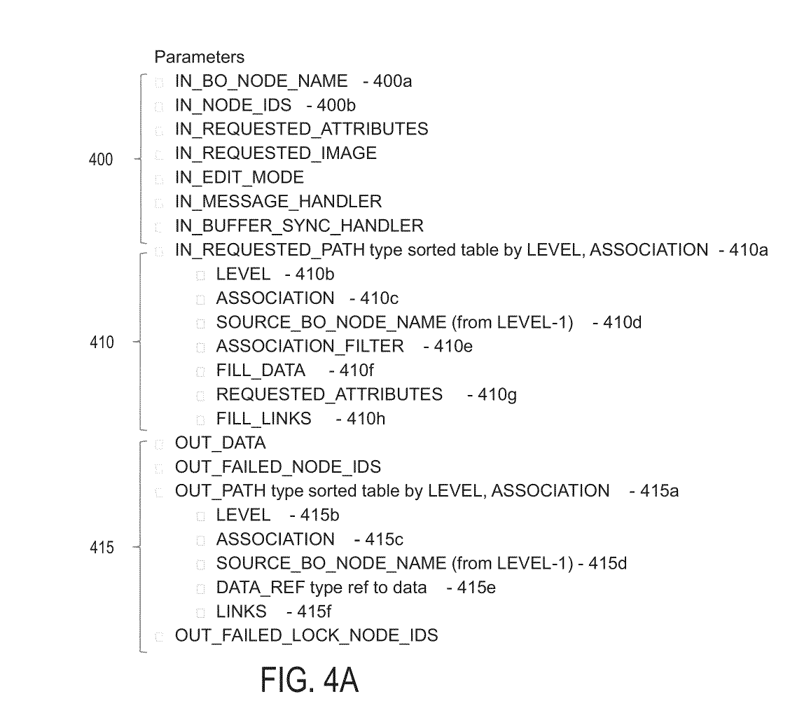

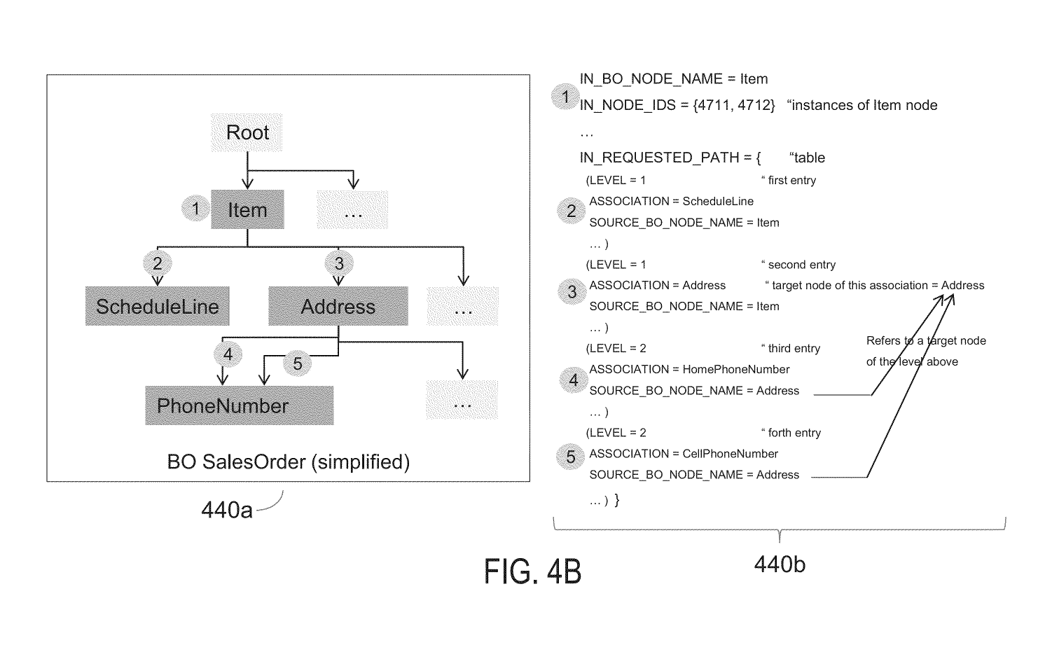

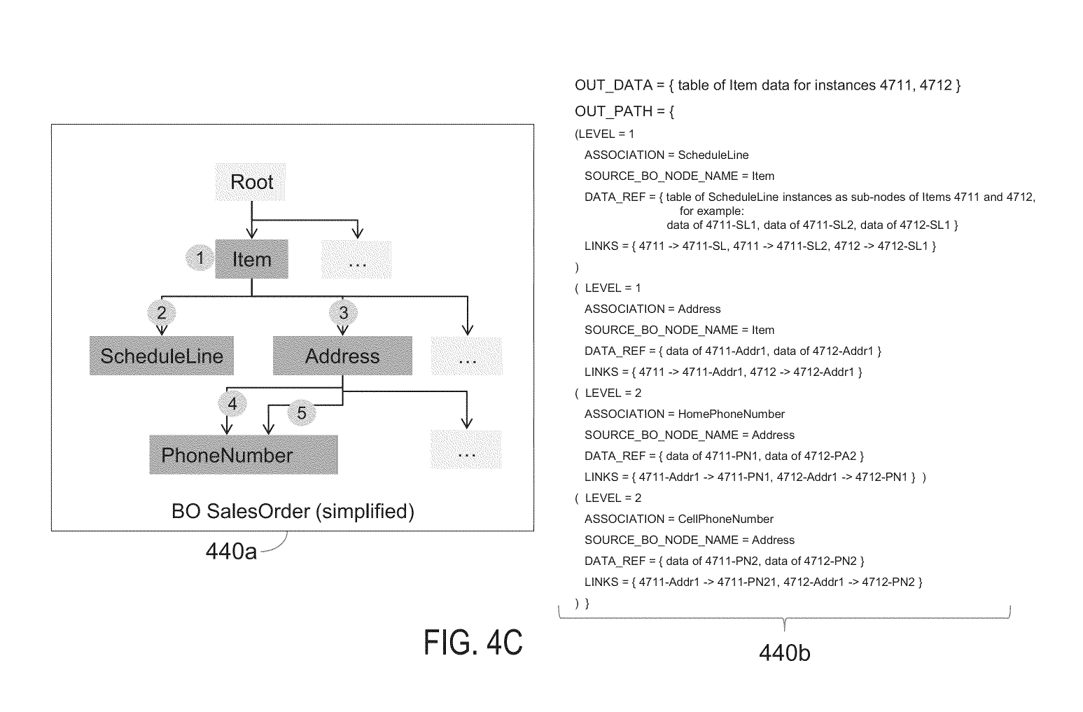

FIG. 4A is a simplified schematic of the parameters for the request function provided by LCP API 210 for generating a coarse-grained data request according to one embodiment of the present invention. As described above in detail, the parameters specify the set of paths (i.e., the tree data structure) through the business-object data structure of the hosted data stored in the data buffers. A first set of identification parameters 400 are traditional parameters provided by an LCP API. A second set of path parameters 410 provide for the specification of the set of paths.

Specifically, a first parameter 400a “IN_BO_NODE_NAME” specifies the initial node of a business object from which hosted data is requested. For example, the business object node may be for sales order items or the like. A second parameter 400b “IN_NODE_IDS” specifies instances of this business object node. For example, the identifier may be for a specific sales order item node instance of the business object. The set of parameters 410, labeled “IN_REQUESTED_PATH”, provides the definition of the sub-path starting from the node instances provided in the set of parameters 400. The first parameter 410a is a table definition of paths which refer to each other. Parameter 410b “LEVEL” and 410d “SOURCE_BO_NODE_NAME” define the tree structure of the paths.

The second parameter 410b “LEVEL” specifies the level of the path definition from which hosted data may be retrieved. Each level refers to an entry of the level above with the parameter 410d “SOURCE_BO_NODE_NAME”. For the first level there is no level above and it refers to the node instances defined by the set of parameters 400.

FIG. 4B is a simplified schematic showing a hierarchy of nodes (e.g., tree structure) of a business object, for example of a sales order business object according to the sales order example being considered. The hierarchy of nodes is shown in FIG. 4 in both diagram format 440a and text 440b. Numerals 1-5 for the various nodes of the sales order business object are shown in the diagram 440a and the text 440b to indicate the same instances of the nodes of the sales order business object. The hierarchy of nodes of the example sales order business object may include a root node (e.g., a specific sales order), item nodes (e.g., specific items of the specific sales order), which are sub-nodes of the root node, and sub-sub-nodes of the root node, which according to the sales order example being considered may include schedule line nodes (e.g., schedule dates for delivery of items), addresses (e.g., shipping addresses or the like). Further sub-nodes may include phone number or other business object data. The hierarchy as shown in FIG. 4B may be for a request associated with the request function provided by the LCP API.

The third parameter 410c “ASSOCIATION” specifies the association of a sub-node of the node specified by the level. That is, the association specifies a connection between the node specified by the level (e.g., the root node for the specific item in the specific sales order business object) and the sub-node. As described briefly above, the association may be the name of the sub-node. According to the sales order example being considered, for the specific item of the specific sales order, a sub-node may be for a delivery date of the specific item, for example, or may be other information for the specific item, such as a material list, a build itinerary, etc. See the example associations in the text 440b shown in FIG. 4B where the associations are the names of the sub-nodes. A fourth parameter 410d “SOURCE_BO_NODE_NAME” may specify a name of the node specified by the parameter LEVEL 410b (e.g., the name of the root node for the specific item according to the example being considered). The SOURCE_BO_NODE_NAME may provide information to the BOPF for the node (e.g., the root node for the specific item) from which the association should be followed to the sub-node. It can therefore be understood that the parameters of the set of path parameters 410 specify a path (e.g., a starting node and an association to a sub-node) through a business-object data structure for hosted data stored in the data buffer. See the example SOURCE_BO_NODE_NAMEs in the text 440b shown in FIG. 4B where the SOURCE_BO_NODE_NAME are the names of the nodes specified by the parameter LEVEL.

To specify further sub-nodes of a node specified by the LEVEL parameter, the LCP API may be configured to provide additional parameters for additional ASSOCIATIONS 410c for the further sub-nodes and for additional SOURCE_BO_NODE_NAMEs 410d. An additional association lengthens the specified path by a node.

According to an alternative embodiment, to specify a further sub-node (e.g., a sub-sub-node of the root node) specified by the LEVEL parameter an additional function call to the request function may be made in the requesting program, the requesting script, etc. The LEVEL 410b for the additional call to the request function entry for the IN_REQUESTED_PATH 410a may be the first sub-node of the node specified by the level parameter in the first call to the request function. The ASSOCIATION 410c for the additional function call may be for the further sub-node.

According to one embodiment, to specify additional specific instances (e.g., additional items) of a business-object data structure (e.g., the specific sales order) of hosted data for retrieval of the hosted data, a requesting program, a requesting script, etc., includes additional function calls to the request function for specifying a path for the additional specific instance.

According to a further embodiment of the present invention, the LCP API may provide optional parameters for specifying the type of hosted data that is retrieved from the data buffers. The LCP API may include an optional parameter “ASSOCIATION_FILTER” 410e for filtering out from the hosted data, which is returned to the client by the server computer, the data for the sub-node (e.g., do not return the data for the delivery date for an item). The LCP API may include an optional parameter “FILL_DATA” 410f, which if included in the function call of the requesting program, requesting script, etc., specifies to the BOPF to return the links between the nodes of the path. The LCP API may include an optional parameter “REQUESTED_ATTRIBUTES” 410g, which if included in the function call in the requesting program, requesting script, etc., specifies specific portions of hosted data at the nodes to be retrieved. The LCP API may include an optional parameter “FILL_LINKS” 410h, which if included in the function call in the requesting program, the requesting script, etc., further specifies to the BOPF how the links are to be retrieved and reported. Specifically, the BOPF may be directed to report the links between nodes (e.g., the links between a specific item and the specific item's sub-items. For example, the reported link may inform a human user of the client that a specific delivery data (i.e., data of a sub-node) is for a specific item (i.e., data of the root node).

According to a further embodiment, the LCP API may provide a third set of parameters 415 for specifying the reporting of hosted data returned from server computer 105 to the client operating on a user computer. A first line 415a “OUT_PATH” is substantially similar to the first line 410a “IN_REQUETS_PATH” and specifies that the hosted data is to be reported based on level and associations. Second parameter 415b “LEVEL,” third parameter 415c “ASSOCIATION,” and fourth parameter 415d “SOURCE_BO_NODE_NAME” specify a path in a tree for reporting data. A fifth parameter 415e “DATA_REF” returns the requested data for this path. A sixth parameter 415f “LINKS” provides on option for having the links between nodes for the specified path reported.

FIG. 4C is a simplified schematic showing a hierarchy of nodes of a business object, for example of a sales order business object for returned sales order business object data according to the sales order example being considered. The hierarchy of nodes is shown in FIG. 4C in both diagram format 440a and text 440b. The hierarchy of nodes (e.g., the tree structure) of the sales order business object data have the same hierarchal structure (e.g., the same tree structure) as the example request shown in FIG. 4B and may be an example response to the request shown in FIG. 4B.

While the foregoing embodiments are described for retrieval of hosted data, alternative embodiments for specifying a set of paths for a tree data structure of hosted data stored in the data buffer provide for writing data according to the set of paths. For example, the LCP API may be configured to provide a write function for writing data according to a set of path for a tree data structure.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A computerized method for accessing coarse-grained business object data stored in a data buffer of a server computer comprising:
providing via a computer system an application program interface (API) having a function for specifying a set of paths through a business object stored as a data structure in a data buffer of a server computer, wherein each of the paths included in the set of paths specifies a plurality of nodes of the business object for accessing hosted data at the plurality of nodes;
receiving via the computer system a set of parameters for the function of the API, wherein the set of parameters specify the set of paths;
issuing via the computer system the set of parameters to the server computer;
retrieving via the computer system hosted data from the plurality of nodes for each path in the set of paths; and
transmitting via the computer system to a client the hosted data retrieved from the plurality of nodes.

2. The method of claim 1, further comprising presenting via the computer system on the client the hosted data according to a tree structure specified by the set of paths.

3. The method of claim 1, wherein the retrieving step includes parsing via the computers system the set of parameters for each path.

4. The method of claim 3, wherein the retrieving step includes traversing each path in the set of paths for the business object stored in the data buffer.

5. The method of claim 1, wherein the set of parameters includes a first parameter for specifying a level of an instance in the business object and an association from the instance to a sub-node of the instance.

6. The method of claim 5, wherein the association is a name of the sub-node or a modeled or implemented relationship to the sub-node.

7. The method of claim 6, wherein the set of parameters includes a name for the instance from which the association specifies the sub-node of the instance.

8. A non-transitory computer readable medium comprises a computer program product, which includes steps for retrieving coarse-grained data for a computerized method including:
providing via a computer system an application program interface (API) having a function for specifying a set of paths through a business object stored as a data structure in a data buffer of a server computer, wherein each of the paths included in the set of paths specifies a plurality of nodes of the business object for accessing hosted data at the plurality of nodes;
receiving via the computer system a set of parameters for the function of the API, wherein the set of parameters specify the set of paths;
issuing via the computer system the set of parameters to the server computer;
retrieving via the computer system hosted data from the plurality of nodes for each path in the set of paths; and
transmitting via the computer system to a client the hosted data retrieved from the plurality of nodes.

9. The computer readable medium of claim 8, wherein the computer program product further comprises presenting via the computer system on the client the hosted data according to a tree structure specified by the set of paths.

10. The computer readable medium of claim 9, wherein the retrieving step includes parsing via the computers system the set of parameters for each path.

11. The computer readable medium of claim 10, wherein the retrieving step includes traversing each path in the set of paths for the business object stored in the data buffer.

12. The computer readable medium of claim 11, wherein the set of parameters includes a first parameter for specifying a level of an instance in the business object and an association from the instance to a sub-node of the instance.

13. The computer readable medium of claim 12, wherein the association is a name of the sub-node or a modeled or implemented relationship to the sub-node.

14. The computer readable medium of claim 13, wherein the set of parameters includes a name for the instance from which the association specifies the sub-node of the instance.

15. The computer readable medium of claim 13, wherein the set of parameters includes a first parameter for specifying a level of an instance in the business object and a set of associations from the instance to set of sub-nodes of the instance.

16. A computer system configured for accessing retrieving coarse-grained data business object data stored in a data buffer of a server computer comprising:
a set of processors configured to execute computer code; and
a set of memories respectively coupled to the set of processors and configured to store computer code and transfer the computer code to the set of processors for execution, wherein the computer code includes:
computer code for providing via a computer system an application program interface (API) having a function for specifying a set of paths through a business object stored as a data structure in a data buffer of a server computer, wherein each of the paths included in the set of paths specifies a plurality of nodes of the business object for accessing hosted data at the plurality of nodes;
computer code for receiving via the computer system a set of parameters for the function of the API, wherein the set of parameters specify the set of paths;
computer code for issuing via the computer system the set of parameters to the server computer;
computer code for retrieving via the computer system hosted data from the plurality of nodes for each path in the set of paths; and
computer code for transmitting via the computer system to a client the hosted data retrieved from the plurality of nodes.

17. The computer system of claim 16, wherein the computer code further includes computer code for presenting via the computer system on the client the hosted data according to a tree structure specified by the set of paths.

18. The computer system of claim 17, wherein the retrieving step includes parsing via the computers system the set of parameters for each path.

19. The computer system of claim 18, wherein the retrieving step includes traversing each path in the set of paths for the business object stored in the data buffer.

20. The computer system of claim 19, wherein the set of parameters includes a first parameter for specifying a level of an instance in the business object and an association from the instance to a sub-node of the instance.
